(19) United States
(12) Patent Application Publication
(10) Pub. No.: US 2013/0343049 A1
(43) Pub. Date: Dec. 26, 2013

(54) User configured illuminated display stand

(71) Applicant: Doug Coberley, Kissimmee, FL (US)

(72) Inventor: Doug Coberley, Kissimmee, FL (US)

(21) Appl. No.: 13/924,099

(22) Filed: Jun. 21, 2013

Related U.S. Application Data
(60) Provisional application No. 61/663,174, filed on Jun. 22, 2012.

(51) Int. Cl. F21V 33/00; A47F 5/00

(52) U.S. Cl. CPC F21V 33/00; A47F 5/00
USPC 362/217.12; 362/375; 362/310; 219/121.72

(57) ABSTRACT

An illuminated display stand that is decorative, functional, and provides a stand for laser milled acrylic or plastic objects. The objects can be formed from any shape with the milled portion providing an outline with definition of most any two dimensional item. The milling of the object can include various depths and widths wherein the illumination from the display stand will highlight the object.

### PRIORITY CLAIM

In accordance with 37 C.F.R. 1.76, a claim of priority is included in an Application Data Sheet filed concurrently herewith. Accordingly, the present invention claims priority of U.S. Provisional Patent Application No. 61/663,174, entitled “ILLUMINATED DISPLAY STAND”, filed Jun. 22, 2012. The contents of which the above referenced application is incorporated herein by reference.

### FIELD OF THE INVENTION

The present invention relates to illuminated display stands and more particularly to an illuminated display stand for highlighting milled translucent objects.

### BACKGROUND OF THE INVENTION

Lighting devices are used in nearly all areas in modern culture. Lights are used generally to allow people to see indoors and when ambient light is insufficient. Lighting is used during the night because of the need to see and work, but also because many people, especially children, have varying degrees of fear of the dark. As such, children have often requested lights to be left on throughout the night which has led to child focused night-lights.

More recently lighting displays have been designed and used to draw the attention of people nearby, sometimes for marketing purposes, other times to showcase items of importance. It is a natural tendency to feel pride of accomplishments and when appropriate, to show those accomplishments off through means of a display. Many displays incorporate lighting to set off the item from the surrounding environment; museums create special lighting around artworks, display cases have focused lights to draw attention to the items inside.

There are numerous illuminated display stands. For instance, U.S. Pat. No. 3,226,865 discloses an illuminated display stand wherein the backside of a transparent object is engraved by removing a layer of paint. The stand provides a light reflective surface by use of a frontal light shining through the transparent material and striking a reflective surface.

U.S. Pat. No. 5,103,581 discloses an illuminated apparatus mounted to an exterior of a dwelling for alerting the location of a delivery site, such as a pizza delivery.

U.S. Pat. No. 5,124,890 discloses a display board that consists of transparent acrylic plastic plates in which surface desired letters or pictures are grooved, and a panel made by fitting together a number of the bricks of transparent acrylic plastic. The light receiving edges of the plate and bricks are colored to produce a colored light. This invention utilizes light-bulbs that when turned on illuminates the edges from the grooves cut in the plate and from the emerging edge of the brick.

U.S. Pat. No. 2,623,312 discloses a sign which may be illuminated wherein edge lighting is employed to obtain illumination of the legend, the sign includes inscribing indicia on the backside of the sign, wherein indicia illumination may be obtained from a light source of given intensity disposed near an edge of the sign, particularly in stances where the distance between the light source and the most remote indicia is relatively large, or where the number of indicia on the sign is relatively great.

What is lacking in the prior art is an illuminated display stand that is ornamental in and of itself, can be configured and re-configured by a user to personalize the display, and employs upward lighting to provide an illuminated display stand for use in illuminating milled translucent objects and other objects placed upon the stand.

### SUMMARY OF THE INVENTION

An illuminated display stand for laser milled acrylic or plastic objects, or other objects of similar size, which would benefit from being lit from the bottom for display purposes. The objects can be formed from any shape with the milled portion providing an outline with definition of most any two dimensional item. The milling of the object can include various depths and widths wherein the illumination from the display stand will highlight the object. The laser milled object can also serve as a backing or frame for opaque objects, such as photographs, certificates, or other similar objects to be displayed.

The base plate can be formed to any geometric shape, such as a rectangle or other polygon, or an ellipse, based on the overall shape design. Light is focused upward by a reflective top surface of the base plate and opaque vertical panels. The vertical panels fit into a groove on the upper surface of the base plate to hold them in place. This groove can form to match the geometric shape of the base plate, or form a different geometric shape. The vertical panels can be a uniform height or varied depending on the type of display sought. Additionally, having additional reflective surfaces within the enclosure to help focus light towards the objects displayed can be incorporated, an example of this is having the front vertical panels have an inwardly reflecting surface so that more light from the internal light source will reflect up towards an opaque object on display increasing the overall illumination of the display.

When displaying translucent objects, such as laser milled plastic, acrylic, or similar objects, the bottom surface of the laser milled object should be conjugate to the mounting groove, where the two surfaces in contact pair together, to aid in light passing into the edge of the translucent object to utilize total internal reflection to illuminate the laser etching, known as edge lighting.

It is an objective of the instant invention to provide an illuminated display stand that is decorative and available for illuminating objects, especially laser milled translucent objects.

Still another objective of the instant invention is to provide an illuminated display stand for holding of translucent objects milled by use of a process that engraves plastic or acrylic pieces wherein edge lighting enhances the engraved element.

It is another objective of the instant invention to provide an illuminated display stand having an enclosure which encapsulates an LED light source.

It is another objective of the instant invention to provide an illuminated display stand having a top surface with grooves for positioning of user-configured objects for display purposes.

It is a further objective of the instant invention to provide an illuminated display stand having an enclosure having a reflective base plate and opaque sidewalls having reflective characteristics to further concentrate and direct lighting towards the objects that are displayed. In addition to reflecting light upwards, the sidewalls may be milled allowing illumination of indicia placed thereon.

It is a further objective of the instant invention to disclose the use of laser milled objects wherein the resulting indicia engraved thereon may receive various depths and thicknesses burn for use in diffracting light for enhancing of the displayed item.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a front view of the present invention without interchangeable front or side panels;

FIG. 2 is rear view of the present invention;

FIG. 3 is a top view of the present invention;

FIG. 4 is a bottom view of the present invention;

FIG. 5 is a top view of the base plate of the present invention;

FIG. 6 is a bottom view of the top plate of the present invention;

FIG. 7 is a side view of the present invention, without interchangeable front or side panels;

FIG. 8 is a side view of a fastener of the present invention; and

FIG. 9 is a perspective view of the present invention illustrating how the positionable objects engage with the illuminated display.

### DETAILED DESCRIPTION OF THE INVENTION

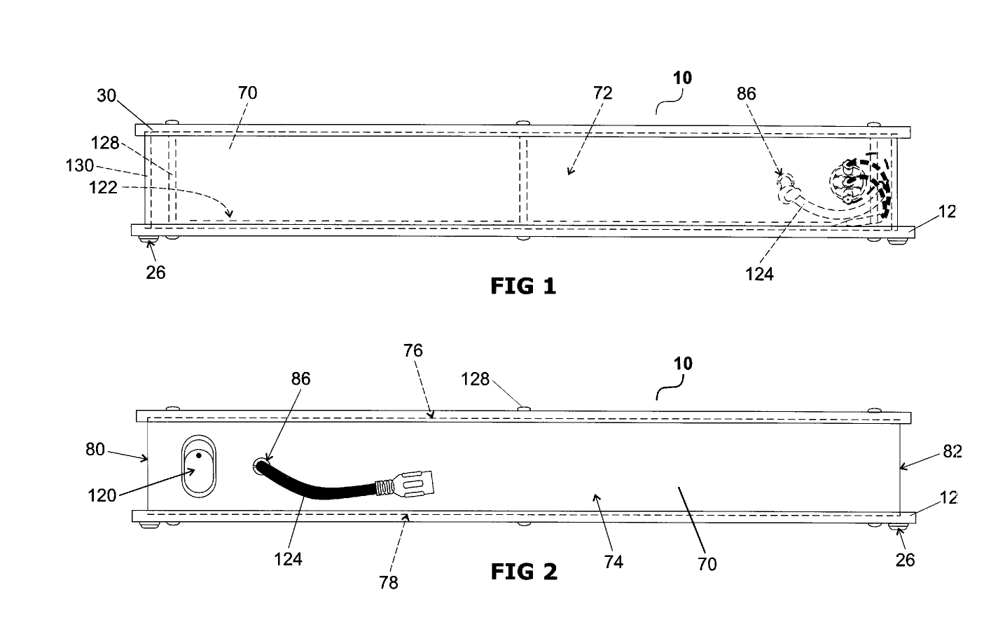

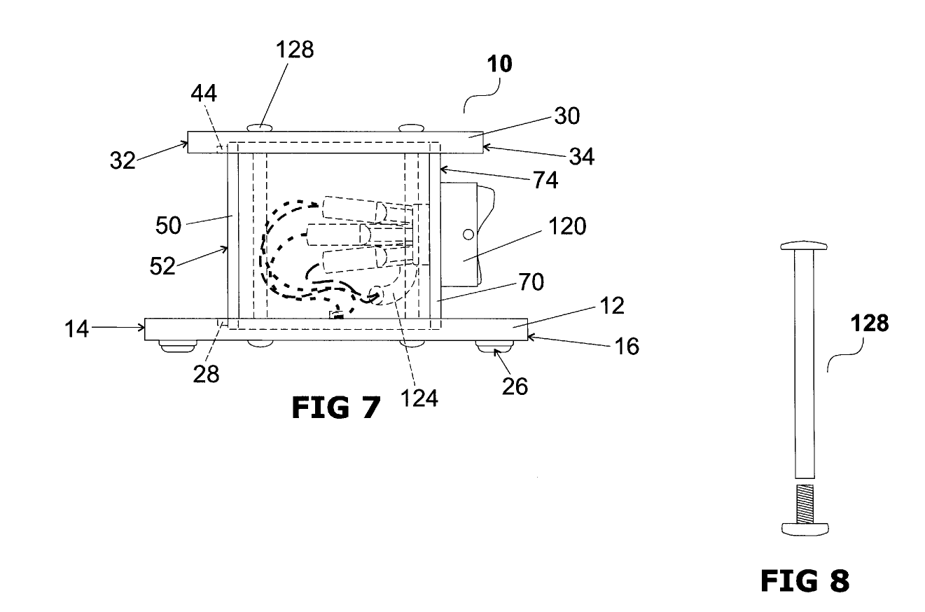

FIGS. 1-9, which are now referenced, illustrate one embodiment of the present invention; a rectangular shaped user configured illuminated display. As illustrated in FIG. 1, the illuminated display 10 includes a substantially rectangular base plate 12, a top plate 30, a sidewall support structure 130, and a light source 122 with electricity from a power cord 124.

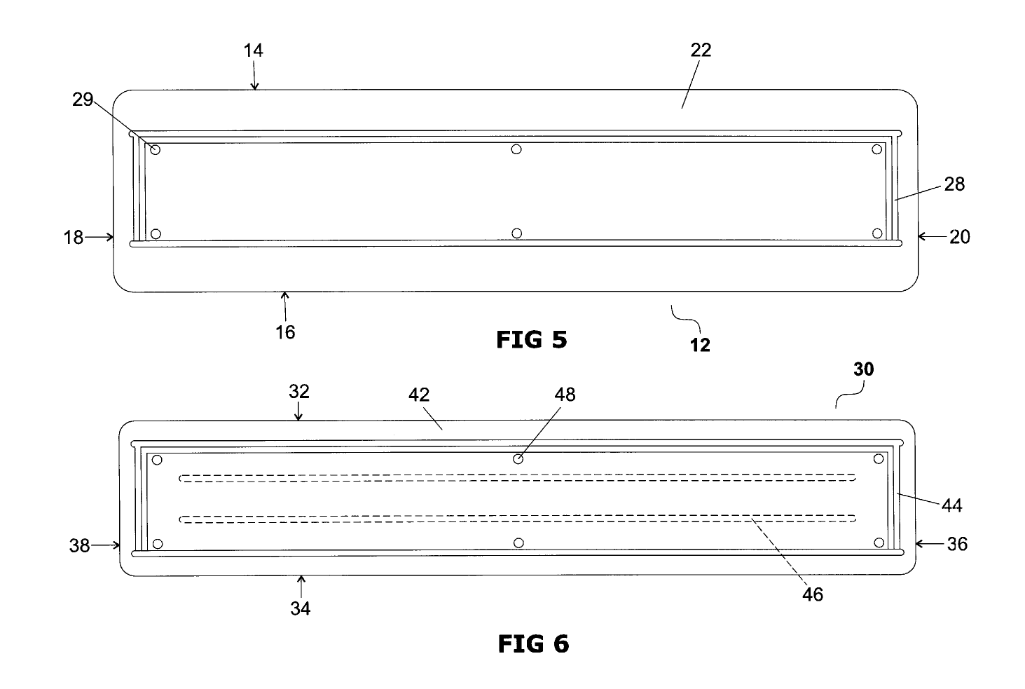

The base plate 12 includes a front edge 14, a rear edge 16, a right edge 18, a left edge 20, a bottom surface 24, and an upper surface 22 which is preferably highly light reflective. The reflective upper surface 22 may be integral with the base plate 12 or it may be a coating which is subsequently applied to the base plate 12. The base plate 12, as depicted in FIG. 5, also has a base plate support groove 28 on the reflective base plate upper surface 22. The base plate support groove 28 is spaced inwardly from the front, rear, left, and right edges of the base plate 12. Additionally, as illustrated in FIGS. 4 and 5, the base plate includes base plate fastener apertures 29 which are used in combination with fasteners 128 to hold the illuminated display 10 together.

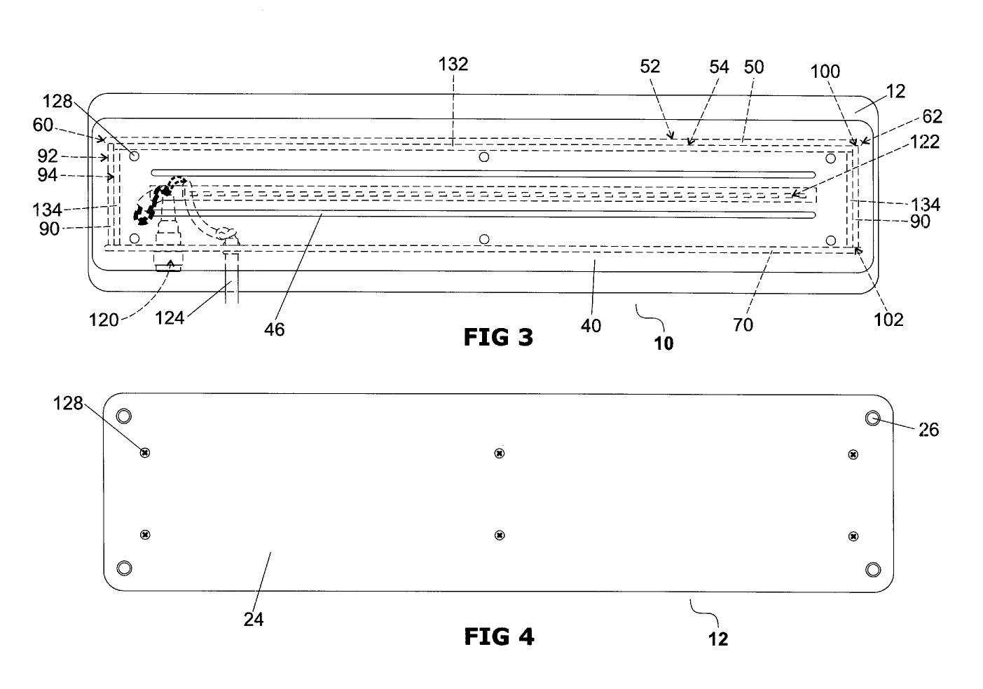

The sidewall support structure 130 extends vertically from the base plate 12, and forms an upstanding enclosure having an interior space or volume. As illustrated in FIG. 3, the sidewall support structure 130 is formed from a front wall 132, two side walls 134, and an opaque rear wall panel 70. The rear wall panel 70 further includes an inner surface 72, an outer surface 74, a top edge 76, a bottom edge 78, a right edge 80, and a left edge 82. In one embodiment, the front wall 132 and side walls 134 of the sidewall support structure 130 can be made entirely of translucent material, such as acrylic or other similar material. Alternatively, the sidewall support structure 130 can be formed such that only specific regions on the front wall 132 and side walls 134 are translucent.

The top plate 30 has and upper surface 40 and a lower surface 42, a front edge 32, a rear edge 34, a right edge 36, and a left edge 38. The upper surface of the top plate 40 includes at least one object mounting groove 46, and in the preferred embodiment it includes two object mounting grooves 46. The lower surface 42 of top plate 30 includes a top plate support groove 44. The top plate support groove 44 is spaced inwardly from the front, rear, and side edges of the top plate 30 in the preferred embodiment. The distance that the groove is spaced from the front, rear, and side edges of the top plate 30 can vary. The support groove 44 can also be along the front, rear, and side edges of the top plate 30. The top plate 30 is secured on top of the sidewall support structure 130 by fasteners 128 passing through top plate fastener apertures 48. The sidewall support structure 130 engages with the base plate 12 and the top plate 30 in the base plate support groove 28 and top plate support groove 44, respectively, to prevent the sidewall support structure 130 from moving with respect to the base plate 12 or the top plate 30. As illustrated in FIG. 6, the top plate 30 has top plate fastener apertures 48 to engage with the fasteners 128. As illustrated in FIGS. 3 and 6, the upper surface of the top plate 40 has an object mounting groove 46 for resting items to be displayed on the top of illuminated display 10.

The illuminated display also includes an interchangeable front wall panel 50 and two interchangeable side wall panels 90. The interchangeable front wall panel 50 has an outer surface 52, an inner surface 54, a top edge 56, a bottom edge 58, a right edge 60 and a left edge 62. Each of the two interchangeable side wall panels 90 has an outer surface 92, an inner surface 94, a top edge 96, a bottom edge 98, a front edge 100, and a rear edge 102. These interchangeable wall panels are also supported between the base plate 12 and the top plate 30 by the base plate support groove 28 and the top plate support groove 44, respectively. The top plate support groove 44 is designed to be a greater depth than the base plate support groove 28, so that when the interchangeable front wall panel 90 or interchangeable side wall panels 90 are positioned in the base plate support groove 28, the top plate support groove 44 overlaps the top edge of the front panel 56 and the top edge of the side panels 96 and prevents the panels from moving. However, when the interchangeable front wall panel 50 or interchangeable side wall panels 90 are fully inserted into the top plate support groove 44, the base plate support groove 28 does not overlap with the bottom edge of the interchangeable front wall panel 58 or the bottom edge of the interchangeable side wall panels 98, allowing the interchangeable wall panels to be removed and changed for a different set of interchangeable wall panels at a user's discretion. When supported in the support grooves 28 and 44, the interchangeable front wall panel 50 and two interchangeable side wall panels 90 are predominantly flush with the front wall 132 and side walls 134 of the sidewall support structure 130. The two interchangeable side wall panels are supported adjacent to one of the ends of each of the interchangeable front wall panel 50 and rear wall panel 70 respectively. Each of the two interchangeable side wall panels 90 are secured to the interchangeable front wall panel 50 along the front edge of the interchangeable side wall panels 100. Each of the two interchangeable side wall panels 90 are secured to the rear wall panel 70 along the rear edge of the interchangeable side wall panel 102.

The inner surface of the interchangeable front wall panel 54, the inner surface of the rear wall panel 72, and the inner surfaces of the interchangeable side wall panels 94 have a light reflective surface. This inner surface is preferably highly reflective of visible light. Alternatively a coating or a layer of light reflective material can be applied to the inner surfaces of the interchangeable front wall panel 54, the rear wall panel 72, and the interchangeable side wall panels 94.

Fasteners 128 are secured to the base plate 12 and to the top plate 30. The present invention uses bolts, as illustrated in FIG. 8, as fasteners 128. The fasteners 128, secure the interchangeable front wall panel 50, rear wall panel 70, and two interchangeable side wall panels in the between the base plate 12 and top plate in the base plate support groove 28 and the top plate support groove 44. Fasteners 128 also permit the illuminated display to be easily disassembled and for parts to be reconfigured by a user. In the preferred embodiment, fasteners 128 enable the top plate 30 to be removed from the sidewall support structure 130 so that a user can gain access to the interior space or enclosure where the light source 122 is housed.

The light source 122 within the enclosure formed by the sidewall support structure 130 is preferably an LED (Light Emitting Diode). In a preferred embodiment a plurality of LEDs are secured along a strip within the enclosure. The strip is positioned along the base plate 12 and extends along the enclosure in a longitudinal direction predominantly parallel to the object mounting groove 46 on the top plate upper surface 40, as illustrated in FIGS. 1 and 3. An electrical power cord 124 is connected to the illuminated display 10 through a power cord aperture 86. The power cord aperture 86 is preferably located in the rear wall panel 70. As illustrated in FIGS. 1, 2, 3, and 7 an electrical power switch 120 is provided to turn on and off the electrical power to the LED light source 122.

Feet 26 are secured to the bottom surface of base plate 24, as illustrated in FIGS. 1, 2, 4, and 7. In the preferred embodiment there are four feet 26. However, any number of feet can be employed. Feet 26 are preferably formed of a material which will not mar or damage a surface on which the illuminated display 10 is set. In the preferred embodiment the feet 26 are made from rubber. The feet 26 raise the bottom surface 24 of base plate 12 and create a space between the base plate 12 and the surface on which the illuminated display is placed, as illustrated in FIGS. 1, 2, and 7. Feet are preferably secured the base plate bottom surface 24 by glue or similar adhesives. The base plate bottom surface 24 can optionally be provided with recesses into which the feet 26 can be placed to decrease the distance between the base plate 12 and the surface on which the illuminated display is placed.

Each interchangeable wall panel preferably includes an opaque layer or is composed of opaque material. Milled portions can be carved into each interchangeable wall panel of the illuminated display 10 in the shape of indicia which are visible from the exterior of the illuminated display 10. The milled indicia on the interchangeable front wall panel 64, and milled indicia on the interchangeable side wall panels 104 permit the passage of light through the opaque layer and create pleasing decorative images which can be reconfigured by a user. The interchangeable front wall panel 50, rear wall panel 70, and interchangeable side wall panels 90 can be formed from various colored plastics, so that the milled indicia are various colors when illuminated.

The LEDs of the light source 122 can each provide a light having the same visible wavelength. Alternatively, two or more LEDs can provide light having two or more distinct and different wavelengths. This arrangement produces a light which appears to have two or more distinct colors. These different and distinct colors are visible through the milled indicia on the interchangeable front wall panel 64 and the indicia on the interchangeable side wall panels 104 of the illuminated display 10. A dimmer can also be provided to regulate the electrical power provided to the light source(s) 122. This will vary the brightness or intensity of the light produced by the light source(s) 122. In the preferred embodiment a dimmer is secured to the power cord 124. However, the dimmer can also be secured to another portion of the electrical supply to the light source(s) 122.

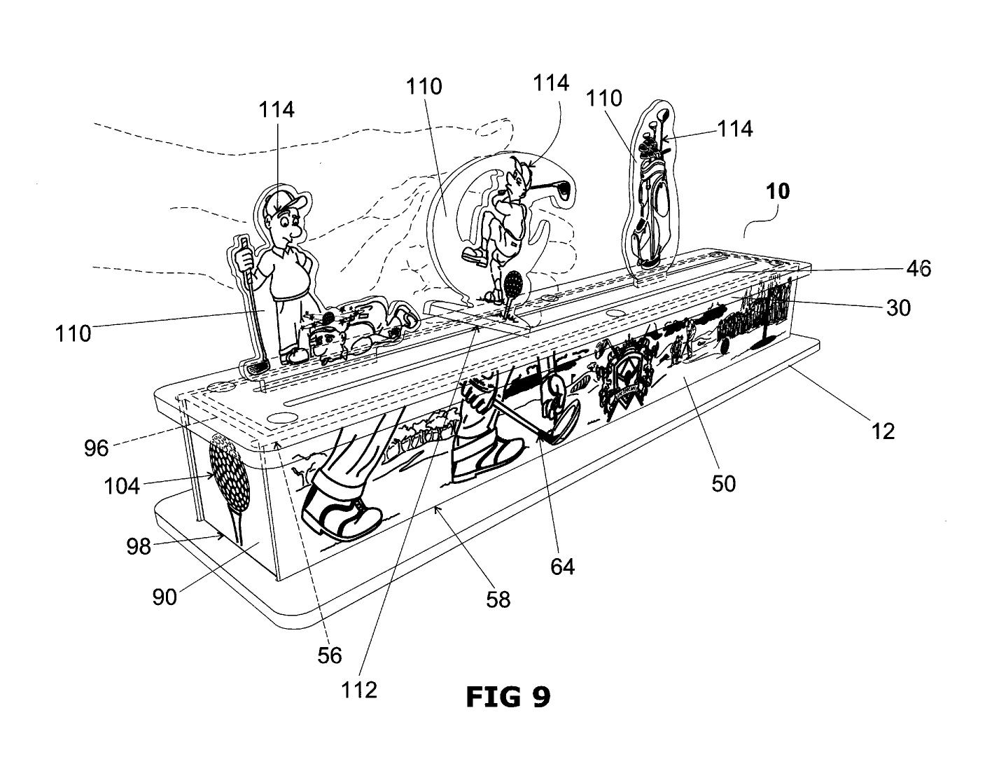

The top plate upper surface 40 is provided with at least one object mounting groove 46. In a preferred embodiment, two object mounting grooves 46 are employed, as illustrated in FIGS. 3 and 9. One or more positionable objects 110 are constructed to be placed within the mounting groove(s) 46 and illuminated by the light source(s) 122. In the present embodiment the positionable objects 110 are formed from a translucent plastic which are readily illuminated by a light source 122 utilizing total internal reflection to illuminate milled indicia on the positionable objects 114 to produce an aesthetically pleasing image. The objects 78 can be milled or formed into various shapes. In FIG. 9 an example of golf related positionable objects 110 are illustrated. Any other imaginable shapes can also be formed and utilized.

Preferably these positionable objects 110 are milled utilizing a laser process. Other types of processes to form indicia on the positionable objects 110 can also be employed. The milling of a positionable object having detail and three dimensional characteristics allows light entering a mounting edge of the positionable object 114, formed as a conjugate surface to object mounting groove 46 surface, to escape through the milled design to create a pleasing image. Additionally, the intensity or brightness of the light produced from the positionable objects 110 can be varied by the milling of the positionable objects 110. The milling of the positionable objects 110 controls the concentration, absorption, and scattering of the light. Thus, visually the intensity or brightness of the light varies. The positionable objects 110 can be milled or formed into various shapes to create letters, words, advertisements, restaurant menus, trophies, instructions, memorial displays, and other viewable indicia.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

1. A user configured illuminated display stand comprising:
an enclosure formed from a horizontally disposed substantially rectangular shaped base plate, front and rear vertically positioned opaque wall panels, first and second vertically positioned opaque side wall panels, and a transparent top plate fastened to said base plate securing said walls and forming a chamber therebetween;
at least one mounting groove extending along a top surface of said top plate;
a light source positioned within said chamber and coupled to a power supply; and
at least one positionable object having a mounting surface conjugate to said mounting groove, wherein said positionable object is illuminated by said light source through said top plate producing an enhanced visual effect of said positionable object.

2. The illuminated display according to claim 1 wherein said base plate is further defined by an upper surface and a bottom surface with a continuous outer edge having a first perimeter, said top plate having a top surface and a lower surface with a continuous outer edge having a second perimeter, said first perimeter greater than said second perimeter.

3. The illuminated display according to claim 1 wherein said upper surface of said base plate includes support grooves for positioning a lower edge of each of said wall panels in a predetermined position spaced inwardly from said first perimeter edge, and a lower surface of said top plate includes reciprocal support grooves for positioning an upper edge of each of said wall panels.

4. The illuminated display according to claim 3 further comprising at least one transparent panel, said transparent panel being constructed and arranged on an inner surface of one of said opaque wall panels so that a user can remove and replace said opaque wall panel from said support grooves without disassembling said illuminated display.

5. The illuminated display according to claim 1, wherein said wall panels are engraved with indicia allowing light from said light source to illuminate said engraved indicia creating an enhanced visual effect.

6. The illuminated display according to claim 1 wherein said top plate is fastened to said base plate by support pins.

7. The illuminated display according to claim 1 wherein said user positionable object with a conjugate mounting surface is a laser milled translucent object having engraved indicia, wherein said light source illuminates said laser milled translucent object by focusing light from said light source through said conjugate surface of said laser milled translucent object, highlighting each side surface and said engraved indicia.

8. The illuminated display according to claim 1 wherein said light source is a Light Emitting Diode strip extending along a length of said chamber predominantly parallel to said mounting groove.

9. The illuminated display according to claim 1 wherein upper surface of said base plate is highly reflective surface.

10. The illuminated display according to claim 1 wherein said wall panels each have an inwardly facing reflective surface.

11. The illuminated display according to claim 1 including a controller switch positioned between said power source and said light source for adjusting the brightness of the light source.

12. The illuminated display according to claim 1 wherein said laser milled positionable objects having engraved indicia are formed from the steps of:
creating computer aided design indicia;
transferring said indicia to a laser milling machine and etching a translucent piece of plastic by use of the laser milling machine to replicate said indicia on said plastic.

13. The illuminated display according to claim 12 wherein said positionable object has a thickness less than said groove to allow placement therein.

14. A user configured illuminated display stand comprising:
an enclosure formed from a horizontally disposed substantially polygon shaped base plate, vertically positioned opaque side wall panels on each side of said base plate, and a transparent top plate fastened to said base plate securing said walls and forming a chamber therebetween;
at least one mounting groove extending along a top surface of said top plate;
a light source positioned within said chamber and coupled to a power supply; and
at least one positionable object having a mounting surface conjugate to said mounting groove;
wherein said positionable object is illuminated by said light source through said top plate producing an enhanced visual effect of said positionable object.

15. The illuminated display according to claim 14 wherein at least one of said side panels includes engraved indicia, said engraved indicia producing an enhanced visual effect when illuminated by said light source.
